(19) United States
(12) Patent Application Publication
(10) Pub. No.: US 2009/0213688 A1
(43) Pub. Date: Aug. 27, 2009

(54) Galvanized conveyor

(75) Inventors: Jakob Tamminga, Orton (CA); Luke Vandergaag, Fergus (CA); Dan Heathers, Kitchener (CA)

Correspondence Address: DILWORTH & BARRESE, LLP, 1000 WOODBURY ROAD, SUITE 405, WOODBURY, NY, 11797, US

(73) Assignee: Jay-Lor International, Orton (CA)

(21) Appl. No.: 12/072,591

(22) Filed: Feb. 27, 2008

(51) Int. Cl. B01F 15/02

(52) U.S. Cl. 366/186; 198/804

(57) ABSTRACT

A conveyor assembly for use with a vertical mixer is disclosed. The conveyor assembly has a conveyor support frame having a galvanized coating to protect the conveyor support frame from rust and wear. The conveyor assembly may further include a protected conveyor bed. The conveyor bed may comprise a polymer such as a high density polyethylene. Alternatively, the conveyor bed may include one or more creases and also be protected by a galvanizing coating.

### FIELD OF THE INVENTION

The present invention relates to conveyor assemblies and more specifically to conveyor assemblies having a protective galvanized coating for use with vertical mixers.

### BACKGROUND

Conveyor assemblies are used to transport animal feed from a feed source to a deposit location where it may then be either consumed by an animal or managed by a farmer for eventual consumption by an animal. For example, a conveyor may transport bulk feed exiting from a vertical mixer to a feed pen, trough or other suitable location for consumption by livestock such as cows, pigs, etc. Often, a series of conveyors, for example a conveyor unit and a wing unit, are used in cooperation to direct the feed from the feed source.

Conveyor assemblies exhibit a higher wear rate and a higher rust rate than other machinery associated with mixing and transporting feed. For example, a feed conveyor often requires replacement or maintenance before the feed mixer to which it is attached during use. Rusting of the conveyor is accelerated by its environment. The feed is typically acidic and additionally contains moisture. Further, water is often added to the feed mix during mixing of the feed. The environment in which the conveyor operates, for example a barnyard environment, also accelerates the rusting and wear of the conveyor as it usually contains mud, dirt, standing water, etc.

Merely painting the conveyor does not solve the problem of rust and wear and can also introduce further problems. Paint application, either brush-on or spray-on, is dependent upon proper weather and humidity conditions for correct application. This dependence on atmospheric conditions often translates into costly construction delays. Further, hollow structures that are painted have no interior protection against corrosion as paint application to the hollow areas of the conveyor can be difficult or nearly impossible.

This problem has been solved to date by either increasing the maintenance and repair on the conveyor or by replacement of the conveyor when it has worn out.

A need therefore exists to provide a conveyor system which requires less maintenance and has a longer life cycle without requiring a large amount of additional cost or time to build.

### SUMMARY

One embodiment of a conveyor system is a protected conveyor system having a support frame coated in a galvanized coating. The conveyor system is adapted to undergo a hot dip galvanizing process where it is exposed to high temperatures and wherein excess material is added to the conveyor system. The conveyor system may further include polymer support beds for a conveyor unit and/or a wing unit of the conveyor system. By adding a protective galvanized coating the conveyor system has extended operational life and reduced maintenance. The galvanizing process also increases the level of protection over brush-applied or spray-applied protective coatings, such as paint, as the interior of hollow elements are protected. Additionally, the galvanizing process is not dependent on environmental conditions for proper application and thereby leads to better assurance of on-time delivery and fewer costly construction delays.

In one illustrative embodiment there is provided a conveyor system for use with a vertical mixer, the conveyor system comprising:
an endless conveying device for transporting material output from the vertical mixer;
a galvanized conveyor support frame for supporting the endless conveying device, the conveyor support frame adapted for connection to the vertical mixer.

In another illustrative embodiment, there is provided a conveyor system for use with a vertical mixer, the conveyor system comprising:
an endless conveying device for transporting material output from the vertical mixer;
a conveyor unit for attachment to the vertical mixer, the conveyor unit comprising:
   a conveyor bed for supporting the endless conveying device;
   a galvanized conveyor unit support frame for supporting the conveyor bed, the conveyor unit support frame comprising:
      a pair of side members having a connection end adapted for pivoting connection with a wing unit; and
      a plurality of support rods connecting the side members;
a wing unit for pivoting connection to the conveyor unit, the wing unit comprising:
   a wing bed for supporting the endless conveying device;
   a galvanized wing unit support frame for supporting the wing bed, the wing unit support frame comprising:
   a pair of side members having a driving end adapted for receiving a driving assembly for driving the endless conveying unit and a connection end for pivoting connection to the connection end of the conveyor unit;
   a plurality of support rods connecting the side members;
      a hydraulic arm support rod bridging the side members, each end of the hydraulic support rod adapted for connection to a hydraulic system for moving the wing unit about the connection end.

In another illustrative embodiment, there is provided a vertical mixer for mixing bulk material and depositing the bulk material in a depositing area, the vertical mixer comprising:
a tub for mixing the bulk material;
an outlet for outputting mixed bulk material;
a conveyor system in communication with the outlet for receiving the output mixed bulk material and guiding the output mixed bulk material to the depositing area, the conveyor system comprising:
   an endless conveying device for transporting material output from the vertical mixer;
a support bed for supporting the endless conveying device; and
a galvanized conveyor support frame for supporting the endless conveying device, the conveyor support frame adapted for connection to the vertical mixer.

In another illustrative embodiment, there is provided a vertical mixer for mixing bulk material, and depositing the bulk material in a depositing area, the vertical mixer comprising:
a tub for mixing the bulk material;
an outlet for outputting mixed bulk material;
a conveyor system in communication with the outlet for receiving the output mixed bulk material and guiding the output mixed bulk material to the depositing area, the conveyor system comprising:
   an endless conveying device for transporting material output from the vertical mixer;
   a conveyor unit for attachment to the vertical mixer, the conveyor unit comprising:
      a conveyor bed for supporting the endless conveying device;
      a galvanized conveyor unit support frame for supporting the conveyor bed, the conveyor unit support frame comprising:
         a pair of side members having a connection end adapted for pivoting connection with a wing unit; and
         a plurality of support rods connecting the side members;
   a wing unit for pivoting connection to the conveyor unit, the wing unit comprising:
      a wing bed for supporting the endless conveying device;
      a galvanized wing unit support frame for supporting the wing bed, the wing unit support frame comprising:
         a pair of side members having a driving end adapted for receiving a driving assembly for driving the endless conveying unit and a connection end for pivoting connection to the connection end of the conveyor unit;
         a plurality of support rods connecting the side members; and
         a hydraulic arm support rod bridging the side members, each end of the hydraulic support rod adapted for connection to a hydraulic system for moving the wing unit about the connection end.

### BRIEF DESCRIPTION OF THE DRAWINGS

FIG. 1 is an isometric view illustrating an example of a conveyor system attached to a vertical mixer;

FIG. 2 is an isometric view illustrating an example of a conveyor system without any shielding;

FIG. 3 is an isometric view illustrating an example of a conveyor system;

FIG. 4 is an isometric view illustrating an example of a conveyor unit;

FIG. 5 is an isometric view illustrating the conveyor unit of FIG. 4 without a conveyor support bed;

FIG. 6 is an isometric view illustrating an example of a wing unit; and

FIG. 7 is an isometric view illustrating the wing unit of FIG. 5 without the wing support bed.

### DETAILED DESCRIPTION

In order to overcome deficiencies and problems associated with previous conveyor systems, a conveyor system is provided that includes a protective galvanized coating for extending the operational life of the conveyor system without adding significant cost or production delays while maintaining functionality of the conveyor system and increasing assurance of on-time delivery. The protective galvanized coating may be applied, for example, using a hot dip galvanizing process.

A galvanized coating offers advantages over bush-applied and spray-applied surface coatings such as paint. Because the hot dip galvanizing process involves total material immersion, it is a complete process. All surfaces are coated. Galvanizing provides both outside and inside protection for hollow structures. Hollow structures that are painted have no interior corrosion protection. Galvanizing also offers the benefit of electromechanical protection and can act as a sacrificial anode. This makes galvanizing a better protective coating than paint. Additionally, galvanizing may be performed at the factory under practically any weather conditions or humidity conditions. Most brush-applied or spray-applied coatings depend upon proper weather and humidity conditions for correct application. This dependence on atmospheric conditions often translates into costly construction delays. The galvanizer's ability to work in any type of weather and environmental conditions allows a higher degree of assurance of on-time delivery. Working under these circumstances, galvanizing can be completed quickly and with consistent short lead times.

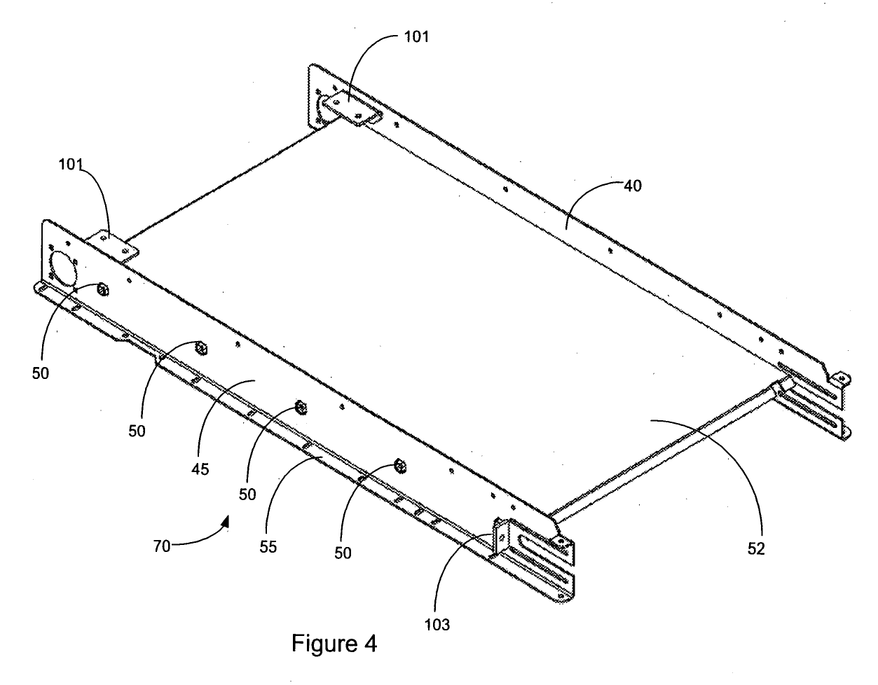

One example of a galvanizing process is a hot dip galvanizing process. The material to be galvanized (for example the conveyor support frame of the conveyor unit 70 and the wing support frame of the wing unit 75 as shown in FIGS. 4-7) is completely immersed in a bath consisting of a minimum of 98% pure molten zinc at a temperature of about 449° C. (840° F.). The zinc metal then reacts with the iron on the steel surface of the immersed support frame to form a zinc/iron inter-metallic alloy. The articles are withdrawn slowly from the galvanizing bath and the excess zinc is removed by draining, vibrating and/or centrifuging. The articles are cooled in either water or ambient air immediately after withdrawal from the bath.

There are, however, problems associated with simply galvanizing a previously designed conveyor system. The nature of the galvanizing process involves very high temperatures which can result in damage to prior conveyor assemblies. For example, damage can be caused during the cooling process as various components of a conveyor system cool at different rates and can be damaged or destroyed during the galvanizing process. Overcoming this problem is difficult as coating the components separately results in the tolerances changing and the components not fitting together properly following the galvanizing process and further because flat and straight components tend to be more difficult to galvanize. The steel being galvanized will warp due to the stresses imparted from manufacturing the steel, working and welding the steel and dissimilar metals, for example a square tube and flat steel. Putting brake marks (slightly creasing the flat steel) can prevent warping of the flat steel. Further, sealed hollow support rods and hydraulic arm support rods, as are present in prior conveyors, can explode when the gas inside the hollow rods is heated and expands when exposed to the high temperatures experienced during galvanizing. There is also a build up of excess impurities at various locations of the conveyor system, which can prevent operation of the conveyor system. As such, conveyor assemblies must be designed which overcome these deficiencies and allow for galvanizing to take place.

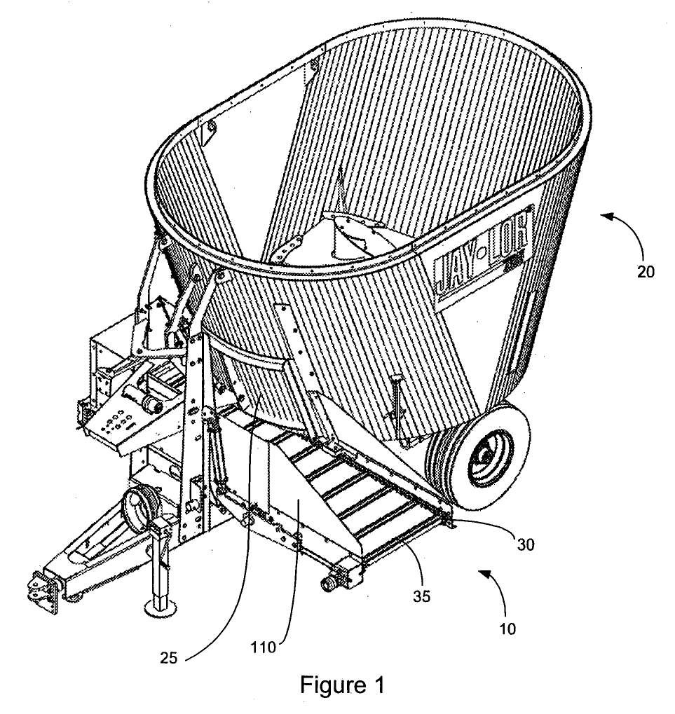

FIG. 1 is an isometric view of a conveyor system 10 coated with a protective galvanized coating attached to a vertical mixer 20 suitable for conveying mixed bulk material exiting through the vertical mixer door 25. Mixed bulk material is typically pushed through the output provided by the open mixer door 25 by an impeller in the vertical mixer 20 and is transported along the conveyor system 10 by the endless conveying device such as an endless chain 30. It will be appreciated that any suitable endless conveying device may be used other than an endless chain 30 such as a rubber belt or a plastic polyvinyl chloride (PVC) belt. The endless chain 30 is connected with a plurality of slats 35. Through the use of the conveyor system 10, mixed bulk material can be deposited in a suitable area for later use. If the mixed bulk material is food, then it may be deposited in a suitable location for consumption. Although FIG. 1 shows the mixer door 25 located on the front of the vertical mixer 20, the door or plurality of doors may be on the side(s) of the vertical mixer 20 or the back of the vertical mixer 20. The conveyor system 10 may be adapted for use with each of these configurations and is not limited to use with vertical mixers having only mixer doors on the front of the vertical mixer. Optional shielding 110 may be used to help guide mixed bulk material along the conveyor system 10 for more efficient depositing of the material.

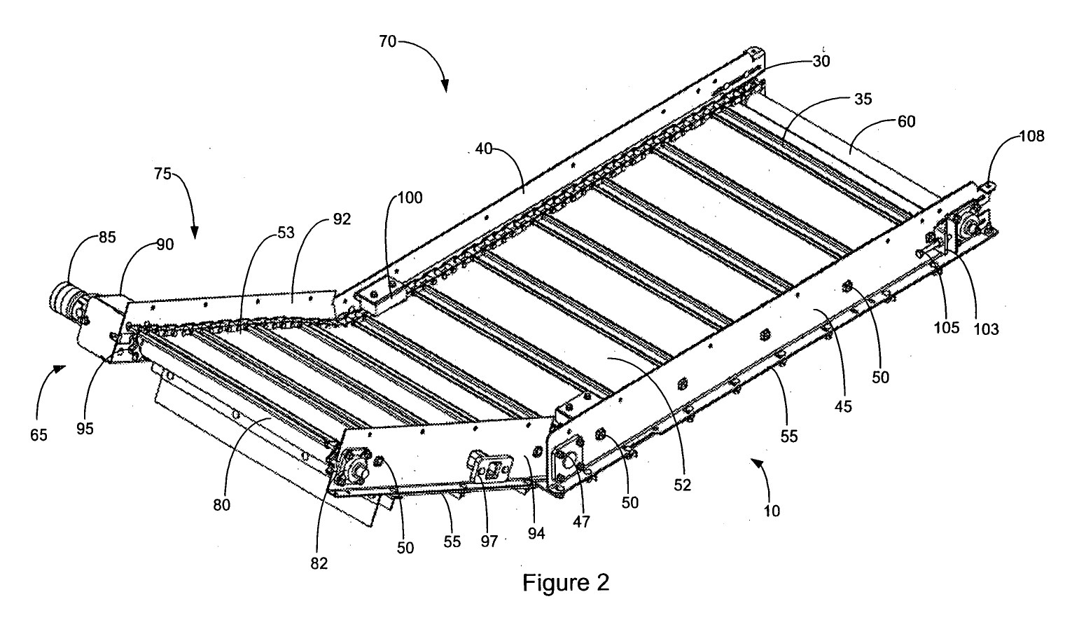

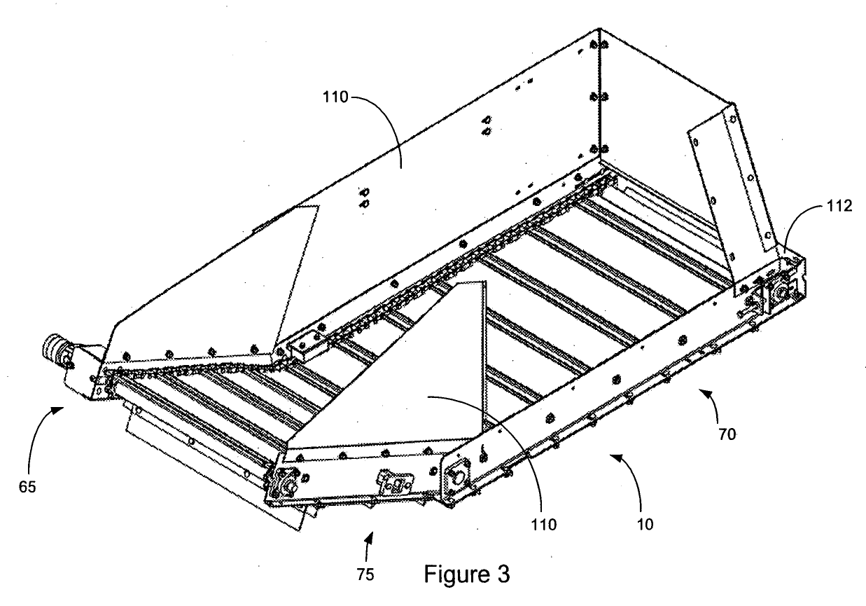

FIG. 2 is an isometric view of an example of a conveyor system 10 having a protective galvanized coating without a shield in place while FIG. 3 is an isometric view of an example of a conveyor system 10 having a shield 110. The conveyor system 10 has two sections, a conveyor unit 70 in pivoting connection to a wing unit 75. Typically the conveyor unit 70 is adapted for connection to the vertical mixer in a suitable location for receiving mixed bulk material through the open door of the vertical mixer. The wing unit 75 extends the conveyor system 10 and allows for more control for the user in placing the bulk material as it exits the conveyor system 10. It will be appreciated by those skilled in the art that the conveyor system 10 may comprise a single section and that the wing unit 75 is not essential to the concept of the conveyor. Generally, the conveyor unit 70 is longer than the wing unit 75, however, the wing unit 75 may be equal to or longer than the conveyor unit 70.

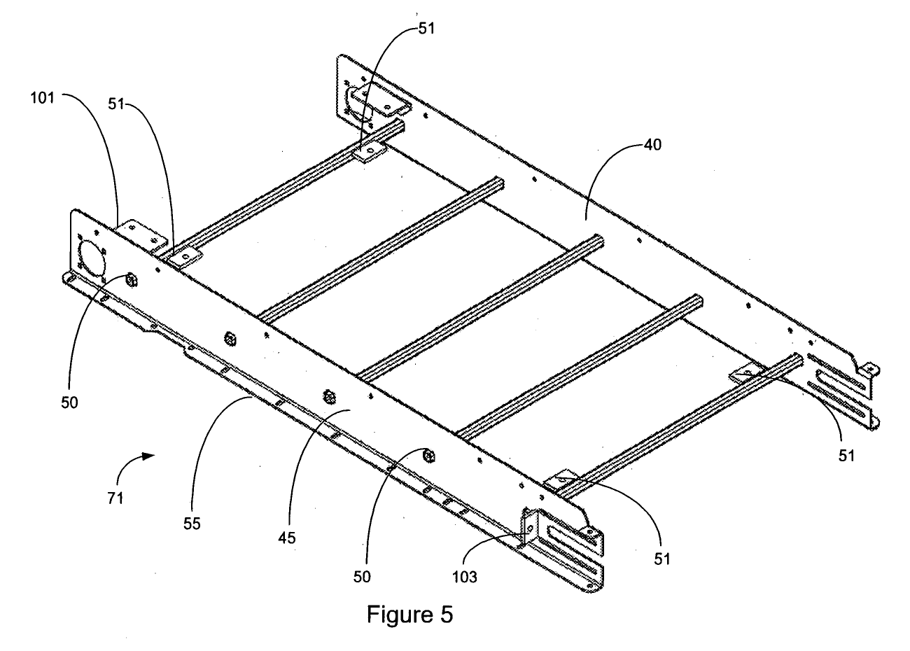

The conveyor unit 70 comprises a set of side members 40, 45 connected by a plurality of support rods 50 which will be shown in more detail in FIGS. 4 and 5. A support bed 52 at least partially supports the endless conveying device such as the endless chain 30 and the slats 35 as well as bulk material deposited thereon. The side members 40, 45 may be rod-like in constructions or may be rail-like in construction as shown in FIGS. 1-7. The side members 40, 45 have an idler end wherein a idler shaft 60 is connected FIG. 2. In order to adjust the tension of the endless chain 30, the idler shaft 60 may be adjustably connected to the side members 40, 45 and may be adjusted by an adjusting screw 105 set through a hole in a tab 103. The idler end may further have a C-bracket 112 (shown in FIG. 3) covering the end of the conveyor unit 70. The C-bracket 112 attaches to the folded attachment tab 108.

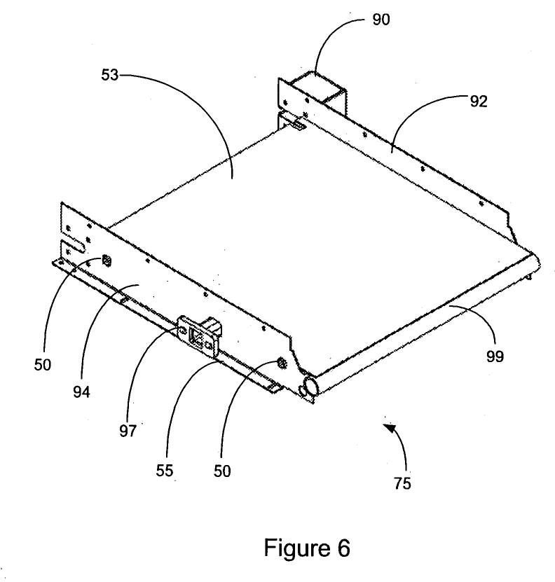

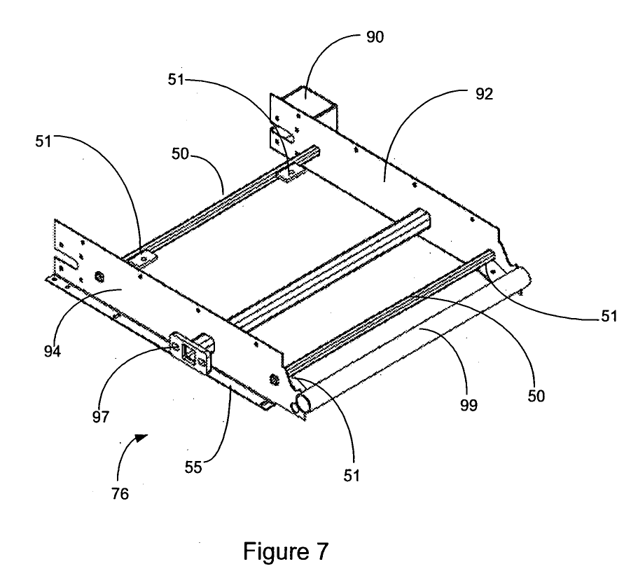

To add strength to the side members, an optional flange 55 may be incorporated into each side member 40, 45. The flange 55 may also be used as an attachment point for attaching the conveyor system 10 to a vertical mixer. Substantially opposite the idler end, the side members 40, 45 have a connection end for pivotal connection to the wing unit 75. A connection tube 47 accommodating a pivot tube (shown in FIGS. 6 and 7 as element 99) between the side members 40, 45 of the conveyor unit 70 and the side members 92, 94 of the wing unit 75 are typically used for allowing pivoting connection of the wing unit 75 with the conveyor unit 70. It will be appreciated that any suitable connection may be used for allowing pivot of the wing unit 75 about the conveyor unit 70. Alternatively, the connection end of the conveyor unit 70 may also be adapted for attachment of a driving assembly 65 for driving the endless chain 30 in the event that a wing unit 75 is not attached.

The wing unit 75 has similar construction to the conveyor unit 70 in that it comprises a pair of side members 92, 94 connected by support rods 50. A support bed 53 makes up the floor of the wing unit 75 and at least partially supports the endless chain 30 and the slats 35 as well as any bulk material deposited thereon.

A driving assembly 65 is used for driving the endless chain 30. A hydraulic motor 85 drives a drive shaft 80 via a coupler 90. The coupler 90 may be a simple 1:1 ratio coupler or may have a different gearing. A cog 95 attached to the drive shaft 80 is used to drive the endless chain 30 as the drive shaft 80 rotates. As outlined above, the driving assembly may attach to the driving end of the wing unit 75 or to the connection end of the conveyor unit 70 in the event that no wing unit 75 is present.

A hydraulic arm support rod 97 is connected between the side members 92, 94 of the wing unit 75 and protrudes from each side member 92, 94. The hydraulic arm support rod 97 is adapted on each end for connection to a hydraulic system for pivoting the wing unit 75. The hydraulic arm support rod 97 may be adapted for example for attachment on each side to a hydraulic arm. The hydraulic arm support arm 97 if hollow is open ended on at least one end and optionally on both ends.

Similarly, the support rods 50 of the conveyor unit 70 and the wing unit 75 if hollow are open ended on at least one end. It is important for the support rod 97 and the support rods 50 to be open to the atmosphere when hollow so that during the galvanizing process, the high temperatures do not cause a pressure build-up in the sealed tubes. Prior conveyor assemblies had sealed tubes connecting between the side members of the conveyor and would be damaged or even explode during the galvanizing process due to pressure build up resulting from the high temperature process making this process impossible to be carried out while maintaining the structural integrity of the conveyor system. In one embodiment, the support rods 50 and the hydraulic arm support rod 97 are punched through each of the side members 92, 94 and are open ended thereby ensuring that no pressure builds up during the galvanizing process. In an alternative embodiment, the support rods 50 and the hydraulic arm support rod 97 are solid thereby, for example inverted angle iron, ensuring that no gas is trapped inside the support rods 50 and the hydraulic arm support rod 97 during galvanizing.

FIG. 4 is an isometric view of an example of the conveyor unit 70 showing the conveyor support bed 52. Another problem associated with galvanizing a prior conveyor system is that the support bed cools at a different rate than the support members 40, 45 and the support rods 50 causing the support bed to warp and be damaged. One possible solution is to galvanize the support frame of the conveyor unit before attachment of the support bed 52. However, this leaves the support bed 52 unprotected allowing for increased wear and corrosion. The support bed 52 may be galvanized separately, however, as outlined above, flat surfaces tend to be difficult to galvanize and can warp during the galvanizing process. One embodiment of the present invention provides for a polymer, non-metallic, support bed to be used. For example, a support bed 52 made from high density polyester (HDPE) or a nylon can be used. Such a support bed 52 does not rust or corrode and has been shown to have high durability and low wear. In addition, if the support bed 52 wears out before the rest of the conveyor system, a user can simply replace the bed by disconnecting it and attaching a new polymer support bed 52. By galvanizing the support frame (the hydraulic arm support rod 97, frame members 40, 45, 92, 94 and support rods 50) and then attaching a polymer support bed 52, the conveyor system 10 has increased durability and wear characteristics.

FIG. 5 is an isometric view illustrating one embodiment of a conveyor support frame 71 onto which a support bed is attached as shown for example in FIG. 4. The support frame 71 may be immersed in a galvanizing bath for adding a protective coating. As previously outlined, the support rods 50 when hollow are open to the atmosphere to prevent explosion or damage to the support rods 50 during immersion into the hot zinc. Additionally, the tab 103 is raised from the flange 55 to prevent impurity build up from the galvanizing process. Also included in this embodiment are a plurality of connection elements 51 onto which the support bed may be fastened. The connection elements 51 are used when the support bed is a polymer floor. If a steel support floor is to be used, it may be bolted to the support rods 50 or the connection elements 51 as welding can damage the galvanizing and the gases produced when welding are highly dangerous. Optionally, the steel support bed may be coated with polymer such as a spray-on polymer for example HDPE or alternatively nylon to add a protective coating to the steel support bed. Another advantage of using a polymer support bed such as an HDPE floor or a nylon floor or a steel support floor coated in a polymer is that the noise generated by the endless conveying device, especially an endless chain connected with a plurality of slats, hitting the support bed 52 is reduced. This is beneficial if the bulk material is feed as reducing noise reduces the impact of the machine on the livestock around the mixer and conveyor system. Alternatively, the support bed 52 may be steel and have creases incorporated therein to allow for separate galvanizing of the floor for later attachment to the support frame 71.

Also shown in FIGS. 2, 3, 4 and 5 is a wear block tab 101 onto which a wear block 100 is attached. The wear block 100 may be made of Teflon® or any suitable material such as HDPE or nylon. The wear block 100 serves to keep the endless conveying device in proximity to the support bed 52 of the conveyor unit 70 and the wing unit 75 when the wing unit 75 is placed in a position non-parallel to the conveyor unit 70. The wear block tab 101 is included in the support frame 71 and is immersed in the galvanizer and protected.

FIG. 6 illustrates the wing unit 75 with the wing support bed 53 while FIG. 7 illustrates a wing support frame 76, which does not include the wing support bed 53. The wing support frame 76 includes the support rods 50, the hydraulic arm support rod 97, the connection elements 51 and a pivot tube 99 for use with the connection tube 47 (shown in FIG. 2) for pivoting connection of the wing unit 75 with the conveyor unit 70. The coupler 90 may be included with the support frame 76 during galvanizing, while the other elements of the driving assembly 65 such as the shafts, bearings, sprockets, chain with slats, motor and shaft connecter are not galvanized but are attached afterwards. As described above with reference to the conveyor unit support bed 52, the wing unit support bed 53 may be made of a polymer such as HDPE or nylon for attachment to the support frame 76 after galvanizing. Alternatively, the support bed 53 may be steel and coated with a protective polymer coating such as HDPE or nylon. Alternatively, the support floor 53 may be steel and have creases incorporated therein to allow for separate galvanizing of the floor for later attachment to the support frame 76.

By galvanizing the support frames 71, 76 of the conveyor system 10 and providing for either a galvanized, coated or non-metallic support bed 52, 53 as described above, a conveyor system has extended operational life while allowing for consistent lead time and on-time delivery.

While the invention has been described with reference to illustrative embodiments thereof, it will be apparent to those skilled in the art upon a reading of the foregoing that numerous basement ventilators other than the specific illustrated embodiments are attainable, which lie within the spirit and scope of the present invention. It is intended to include all such designs, and equivalents thereof within the scope of the appended claims.

We claim:

1. A conveyor system for use with a vertical mixer, the conveyor system comprising:
an endless conveying device for transporting material output from the vertical mixer; and
a galvanized conveyor support frame for supporting the endless conveying device, the conveyor support frame adapted for connection to the vertical mixer.

2. The conveyor system of claim 1, further comprising a conveyor support bed for supporting the material output from the vertical mixer.

3. The conveyor system of claim 2, wherein the conveyor support frame comprises:
a pair of side members having a driving end adapted for receiving a driving assembly for driving the endless conveying device; and
a plurality of support rods connecting the side members.

4. The conveyor system of claim 1, wherein the plurality of support rods are hollow and have at least one opening to the atmosphere to prevent pressure build up during galvanizing, each support rod being coated by the protective galvanized coating both inside and outside of the support rod.

5. The conveyor system of claim 4, wherein the plurality of support rods extend through each side member and are open at each end.

6. The conveyor system of claim 1, further comprising an adjustable idler shaft, and
wherein the pair of side members have an idler end, opposite the driving end, for adjustably receiving the idler shaft,
each side member comprising a tab in proximity to the idler end, the tab having an adjuster for use with the idler shaft for adjusting the position of the idler shaft and the tension of the endless chain
each side member has a flange at a lower edge of the side member, the tab and the flange being spaced apart a suitable distance to avoid impurity build up from the application of the galvanized coating.

7. The conveyor system of claim 2, wherein the support bed comprises a polymer.

8. The conveyor system of claim 2, wherein the support bed is a high density polyethylene, a nylon, a polyurethane or a polyethylene.

9. The conveyor system of claim 2, wherein the support bed includes a crease and is coated with a protective galvanized coating.

10. The conveyor system of claim 2, wherein the support bed is steel and is coated with a protective coating selected from a plastic polymer coating or a nylon coating.

11. The conveyor system of claim 1, wherein the endless conveying device is an endless chain connected to a plurality of slats.

12. A conveyor system for use with a vertical mixer, the conveyor system comprising:
an endless conveying device for transporting material output from the vertical mixer;
a conveyor unit for attachment to the vertical mixer, the conveyor unit comprising:
a conveyor bed for supporting the endless conveying device;
a galvanized conveyor unit support frame for supporting the conveyor bed, the conveyor unit support frame comprising:
a pair of side members having a connection end adapted for pivoting connection with a wing unit; and
a plurality of support rods connecting the side members;
a wing unit for pivoting connection to the conveyor unit, the wing unit comprising:
a wing bed for supporting the endless conveying device,
a galvanized wing unit support frame for supporting the wing bed, the wing unit support frame comprising:
a pair of side members having a driving end adapted for receiving a driving assembly for driving the endless conveying unit and a connection end for pivoting connection to the connection end of the conveyor unit;
a plurality of support rods connecting the side members;
a hydraulic arm support rod bridging the side members, each end of the hydraulic support rod adapted for connection to a hydraulic system for moving the wing unit about the connection end.

13. The conveyor system of claim 12, wherein each support rod and the hydraulic arm support rod is hollow and has at least one opening to the atmosphere to prevent pressure build up during galvanizing, each support rod and the hydraulic arm support rod being coated by the protective galvanized coating both inside and outside.

14. The conveyor system of claim 13, wherein each support rod extends through each side member and is open at each end, and the hydraulic arm support rod extends through each side member of the wing unit and is open at each end. I don't think we need this claim every one has this (See note above for claim 5)

15. The conveyor system of claim 12, further comprising an adjustable idler shaft, and
wherein the pair of side members of the conveyor unit have an idler end, opposite the connection end, for adjustably receiving the idler shaft,
each side member of the conveyor unit comprising a tab in proximity to the idler end, the tab having an adjuster for use with the idler shaft for adjusting the position of the idler shaft and the tension of the endless chain;
each side member has a flange at a lower edge of the side member, the tab and the flange being spaced apart a suitable distance to avoid impurity build up from the application of the protective galvanized coating.

16. The conveyor system of claim 12, wherein the conveyor support bed and/or the wing support bed comprises a polymer.

17. The conveyor system of claim 12, wherein the conveyor support bed and/or the wing support bed comprises a high density polyethylene, a nylon, a polyurethane or a polyethylene.

18. The conveyor system of claim 12, wherein the conveyor support bed and/or the wing support bed includes a crease and is coated with a protective galvanized coating.

19. The conveyor system of claim 12, wherein the endless conveying device is an endless chain connected to a plurality of slats.

20. The conveyor system of claim 12, further comprising a wear tab connected to each side member of the conveyor unit for placement proximate the connection end of the side member above the travel of the endless conveying device for contacting the endless conveying device when the wing unit is placed in a position non-parallel to the conveyor unit.

21. A vertical mixer for mixing bulk material and depositing the bulk material in a depositing area, the vertical mixer comprising:
a tub for mixing the bulk material;
an outlet for outputting mixed bulk material;
a conveyor system in communication with the outlet for receiving the output mixed bulk material and guiding the output mixed bulk material to the depositing area, the conveyor system comprising:
an endless conveying device for transporting material output from the vertical mixer;
a support bed for supporting the endless conveying device; and
a galvanized conveyor support frame for supporting the endless conveying device, the conveyor support frame adapted for connection to the vertical mixer.

22. The vertical mixer of claim 21, wherein the support bed comprises a high density polyethylene, a nylon, a polyurethane or a polyethylene.

23. A vertical mixer for mixing bulk material, and depositing the bulk material in a depositing area, the vertical mixer comprising:
a tub for mixing the bulk material;
an outlet for outputting mixed bulk material;
a conveyor system in communication with the outlet for receiving the output mixed bulk material and guiding the output mixed bulk material to the depositing area, the conveyor system comprising:
an endless conveying device for transporting material output from the vertical mixer;
a conveyor unit for attachment to the vertical mixer, the conveyor unit comprising:
a conveyor bed for supporting the endless conveying device;
a galvanized conveyor unit support frame for supporting the conveyor bed, the conveyor unit support frame comprising:
a pair of side members having a connection end adapted for pivoting connection with a wing unit; and
a plurality of support rods connecting the side members;
a wing unit for pivoting connection to the conveyor unit, the wing unit comprising:
a wing bed for supporting the endless conveying device;
a galvanized wing unit support frame for supporting the wing bed, the wing unit support frame comprising:
a pair of side members having a driving end adapted for receiving a driving assembly for driving the endless conveying unit and a connection end for pivoting connection to the connection end of the conveyor unit;
a plurality of support rods connecting the side members;
a hydraulic arm support rod bridging the side members, each end of the hydraulic support rod adapted for connection to a hydraulic system for moving the wing unit about the connection end.

24. The vertical mixer of claim 23, wherein the conveyor bed and/or the wing bed comprises a high density polyethylene, a nylon, a polyurethane or a polyethylene.

25. The conveyor system of claim 1, wherein the galvanized coating is applied using a hot dip galvanizing process.
